(19) United States
(12) Patent Application Publication
(10) Pub. No.: US 2006/0056395 A1
(43) Pub. Date: Mar. 16, 2006

(54) Handover for packet switched data

(76) Inventors: Miikka Huomo, Vanlaa (FI); Kari P. Kauranen, Helsinki (FI); Jarmo J. Virtanen, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 11/060,593

(22) Filed: Feb. 18, 2005

(30) Foreign Application Priority Data
Feb. 20, 2004 (GB) 0403829.5

(51) Int. Cl. H04L 12/66

(52) U.S. Cl. 370/352; 370/331

(57) ABSTRACT

There is disclosed a method of handing over communication of packet switched data from a mobile terminal moving between a first routing area defined in a cellular communications network and a second routing area, wherein a temporary logical link identifier has been assigned to said communication in the first routing area, the method comprising the steps of: identifying that the mobile terminal has moved from the first routing area to the second routing area; supplying a temporary handover identity; transmitting packets in a downlink direction to the mobile terminal during a handover period, each packet including the temporary handover identity; during said handover period assigning a new temporary logical link identifier to the mobile terminal and ceasing to include the temporary handover identity in subsequent packets when the new temporary logical link identifier has been assigned.

### BACKGROUND TO THE INVENTION

1. Field of the Invention

The present invention relates to handover for packet switched data in a mobile communications network. The invention is particularly but not exclusively concerned with packet switched (PS) handover in GSM/EDGE radio access networks (GERAN).

2. Description of the Related Art

Broadly speaking telecommunications services are generally divided into two categories: bearer services and tele services. Bearer services typically allow a user to access various forms of communication such as, for example, asynchronous circuit switched data services interworking with the public switched telephone network (PSTN), or packet switched synchronous data services interworking with the packet switched public data network (PSPDN). Tele services on the other hand typically allow a user to access various forms of applications such as transmission of speech, short messaging services and facsimile transmissions.

Bearer services are currently generally adopted in the universal mobile telecommunication system (UMTS). The UMTS network is typically composed of four sub-networks: an access network; a core network; a service mobility control network; and a telecommunication management network. Of these, the access network is responsible for the basic transmission and switching functions required to enable a mobile station (MS) to access a fixed network resource over the radio interface (known as the Uₘ interface).

Bearer services (generally referred to as bearers) which generally allow a user to access various forms of communication over the UMTS terrestrial radio access network (UTRAN) are already well defined, and are known as UTRAN bearers.

An alternative to the UTRAN is the GSM/EDGE radio access network GERAN. In GERAN, new radio access bearers are defined which are nevertheless aligned with the bearers offered by UTRAN (the UTRAN bearers). The basic architecture of the access network and core network is the same in each of the a UMTS and a GSM/EDGE system. The main relevant functional elements are illustrated in FIG. 1.

Referring to FIG. 1, a mobile station MS communicates with a first base station subsystem (BSS), denoted BSS1, in a GERAN over the radio interface (Uₘ interface). A base station subsystem typically includes one or more base transceiver stations (BTS). In the example BSS1 includes two BTSs denoted BTS1 and BTS2, and a base station controller (BSC) associated with the base transceiver station(s). BSS1 communicates with a mobile switching centre (MSC) in the core network (CN) over a circuit switched signalling interface (known as the A interface). BSS1 also communicates with a first serving GPRS support node (SGSN) in the core network, denoted as SGSN1, over a packet switched data interface (known as the Gb interface). The MSC further also communicates with SGSN1 over a circuit switched interface (known as the Gs interface).

SGSN1 also communicates with a gateway GPRS support node GGSN in the core network, over a Gn interface, to allow connection to packet switched public data networks (PSPDNS) via a Gi interface, or other public data networks. The present invention is primarily concerned with packet switched data transfer.

A second serving GPRS support node in the core network, denoted as SGSN2, communicates with SGSN1 via an interface known as the Gn interface, and is responsible for managing other BSSs in the GERAN network, such as a second BSS, denoted BSS2, and including a BTS identified as BTS3. SGSN2 is connected to BSS2 via a Gb interface.

A typical public land mobile network will have other functional elements, but these are not discussed further herein because they are well known to a person skilled in the art and are not germane to the present invention.

As is also well known, a typical public land mobile network is laid out in a cellular fashion. This is illustrated in FIG. 2, which shows three adjacent hexagonal cells C1, C2 and C3. In the example of FIG. 2, cells C1 and C3 are controlled by a common BTS/BSC, denoted BTS1/BSC, while cell C2 is under the control of a different BTS/BSC, denoted BTS2/BSC. It will readily be appreciated that each cell could have its own BTS/BSC or each BTS/BSC could control a plurality of additional cells. Mobile stations moving or roaming in the network of FIG. 2 are represented by two mobile stations denoted MS1 and MS2. MS1 is shown connected in cell C1, and MS2 is shown connected in cell C2.

The present invention is concerned with handover where a mobile station, such as MS1 in FIG. 2, moves around the network. In the illustrated case of FIG. 2 it is assumed, for the sake of example, that MS1 moves from a source cell C1 to a target cell C2.

Handover of tele-services, e.g. voice channels in the radio domain, is well documented and known in the art. The present invention is concerned with the handover of packet switched data in the logical domain. The invention is particularly but not exclusively concerned with PS handover for the GERAN in A/Gb mode, that is when packet switched data is being transferred via the GERAN network to the core network over the Gb interface under control of commands on the A interface.

Packet switched data is handled in a so-called PS (packet switched) domain which is a logical domain existing above the cellular network which implements radio channels. In the PS domain, routing areas are defined in which logical channels are created for the transfer of packet switched data. A routing area can map onto one or more cells in the cellular network. According to the known GERAN protocols each routing area (RA) is defined by a routing area identifier (RAI) that contains, for example, the mobile network code, the mobile country code, and a code for the routing area. Logical channels are defined in the logical domain by logical link identifiers (LLIs) which are established by the serving GPRS support node (SGSN).

As a mobile station MS moves around, its movement must be handled both at the network (radio) level and at the logical level in the PS domain. If a mobile station changes its routing area, then a routing area update (RAU) is typically sent from the mobile station to the SGSN currently managing the mobile station. If the mobile station MS changes its cell, then a cell update is typically sent from the mobile station to the managing SGSN. To obtain a logical link identifier, the mobile station MS issues an “attach request” to the SGSN, and after an authentication procedure a new attachment is accepted. A local temporary logical link identifier (L-TLLI) is established to establish a logical link between the mobile and the SGSN, the L-TLLI being transmitted in all packets for that particular logical channel. When the mobile station MS moves from one routing area to another routing area, the local temporary logical link identifier L-TLLI may be carried from the old routing area to the new routing area, or a new L-TLLI may be allocated in the new routing area.

When a mobile station moves from an old routing area to a new routing area the status of the TLLI typically changes from a local TLLI (L-TLLI) to a foreign TLLI (F-TLLI). This change in status is typically denoted by altering a single bit in the bit sequence that constitutes the TLLI code in the packets. While this is the case in the current GSM/EDGE standard, it will be appreciated that any code protocol for the TLLI to identify the changes from a local TLLI to a foreign TLLI can be used based on similar principles. If the SGSN changes as a result of a routing area update, then a new local TLLI has to be established during the attachment procedure to the new SGSN, between the mobile station and the new SGSN.

The logical link control ensures reliable transfer of usable data across a wireless network. It is also necessary to ensure that there is a continuous connectivity at the radio link layer while data is actually being transferred. This is handled by handover procedures in the network. Handover is generally implemented when the quality of an existing radio link has deteriorated lower than a minimum requirement of the link quality for the purpose of a particular communication. A new radio link with the best available link quality can be established using handover procedures to maintain a continuous radio connectivity.

For example, with further reference to FIG. 2, when the mobile station MS1 moves from cell C1 to cell C2, it is necessary to maintain good radio connectivity in the transfer from BTS1/BSC to BTS2/BSC. For packet switched data, this also involves logical link control. It is important that PS handover is quickly recognised and accomplished in the target cell C2. It is also important that TLLI collisions are avoided in the target cell. TLLI collisions can exist in the target cell because it is possible, for example, that there may exist in the target cell other mobile stations, for example MS2, which have the same foreign temporary logic link identifier (F-TLLI) as the mobile station MS1 that has just changed cells. If the SGSN therefore continues to transfer data to the mobile station MS1 using its F-TLLI, for example by blind-casting down-link (DL) data, other mobile stations may attempt to receive the message. To overcome this, a new local TLLI is allocated during the attachment procedure to the new SGSN, to be used in all communications succeeding the attachment, following a successful routing update.

Collisions may still occur, however, whilst the handover is incomplete, pending completion of a routing area update and allocation of a new local TLLI.

It is desirable that the mobile station should be reachable in the target cell straight away, without risk of collision, using the same TLLI that it had in the source cell, i.e. before the new attachment procedure has assigned a new local TLLI.

### SUMMARY OF THE INVENTION

It is an aim of the present invention to provide an improved technique which addresses one or more of the above stated problems.

According to one aspect of the present invention there is provided a method of handing over communication of packet switched data from a mobile terminal moving between a first routing area defined in a cellular communications network and a second routing area, wherein a temporary logical link identifier has been assigned to said communication in the first routing area, the method comprising the steps of: identifying that the mobile terminal has moved from the first routing area to the second routing area; supplying a temporary handover identity; transmitting packets in a downlink direction to the mobile terminal during a handover period, each packet including the temporary handover identity; during said handover period assigning a new temporary logical link identifier to the mobile terminal and ceasing to include the temporary handover identity in subsequent packets when the new temporary logical link identifier has been assigned.

The invention also provides in a related aspect apparatus for handing over communications of packet switched data from a mobile terminal moving between a first routing area defined in a cellular communications network and a second routing area, wherein a temporary logical link identifier has been assigned to said communication in the first routing area, the apparatus comprising: a controller operable to identify that the mobile terminal has moved from the first routing area to the second routing area and to supply a temporary handover identify; and a network entity operable to transmit packets in a downlink direction to the mobile terminal during a handover period, each packet including the temporary handover identity; wherein the controller is operable to assign a new temporary logical link identifier to the mobile terminal and the network entity ceases to include the temporary handover identity in subsequent packets when the new temporary logical link identifier has been assigned.

The invention is particularly suitable to be implemented in a GSM/EDGE radio access network (GERAN).

Where the temporary logical link identifier assigned to the communication in the first routing area is an L-TLLI, this can be changed to an F-TLLI after it has been identified that the mobile terminal has move from the first routing area to a second routing area. In that case, each packet can include the F-TLLI during the handover period on the downlink and/or the uplink. Moreover, the temporary handover identity can be included in packets transferred in the uplink direction as well as in the downlink direction.

As there is an advantage in being able to use the F-TLLI in the uplink direction, the invention provides in another aspect Apparatus for handing over communication of packet switched data from a mobile terminal moving between a first routing area defined in a cellular communications network and a second routing area wherein a local temporary logical link identifier has been assigned to said communication in the first routing area, the apparatus comprising a controller operable to identify that the mobile terminal has moved from the first routing area to the second routing area and to change the local temporary logical link identifier to a foreign temporary logical link identifier, wherein the mobile terminal is operable to transmit packets in an uplink direction during a handover period, each packet including the foreign temporary logical link identifier.

Collisions can be avoided in this case by checking the RAI at a serving controller which receives the packets.

Another aspect of the invention provides a method of handing over communication of packet switched data from a mobile terminal moving between a first routing area defined in a cellular communications network and a second routing area wherein a local temporary logical link identifier has been assigned to said communication in the first routing area, the method comprising the steps of: identifying that the mobile terminal has moved from the first routing area to the second routing area; changing the local temporary logical link identifier to a foreign temporary logical link identifier; and transmitting packets from the mobile terminal in an uplink direction during a handover period, each packet including the foreign temporary logical link identifier.

The L-TLLI can be changed to the F-TLLI in accordance with the GSM/EDGE standard by altering the status of one bit in a bit sequence representing the identifier. The temporary logical link identifier can include a packet temporary mobile subscriber identity (P-TMSI), the P-TMSI being included whether the TLLI is local or foreign.

It will be clear that the packets can be data packets and/or signalling packets. It will also be clear that the temporary handover ID can be used on the uplink as well as on the downlink.

Another aspect of the invention provides apparatus for handing over communication of packet switched data in a wireless communications network, comprising: a controller operable to identify in a logical domain that a mobile terminal has moved to a new routing area and to supply in a physical domain a temporary handover identity to the mobile terminal; and a network entity operable to transmit, during a handover period, packets over a wireless interface to the mobile terminal each packet including a the temporary handover identity.

It is a distinct advantage of this aspect that temporary handover identity needs to be supplied only at the physical level and does not affect operations in the logical domain.

Another aspect of the invention provides a method of handing over communication of packet switched data in a wireless communications network, the method comprising: identifying in a logical domain that a mobile terminal has moved to a new routing area and supplying in a physical domain a temporary handover identity to the mobile terminal; during a handover period, transferring packets over a wireless interface to the mobile terminal, each packet including the temporary handover identity.

A further aspect of the invention provides an apparatus for handing over communications of packet switched data from a mobile terminal moving between a first routing area defined in a cellular communications network and a second routing area, wherein a temporary logical link identifier has been assigned to said communication in the first routing area, the apparatus comprising: a controller operable to identify that the mobile terminal has moved from the first routing area to the second routing area and to supply a temporary handover identify; and a network entity operable to transmit packets in a downlink direction to the mobile terminal during a handover period, each packet including the temporary handover identity; wherein the controller is operable to assign a new temporary logical link identifier to the mobile terminal and the network entity ceases to include the temporary handover identity in subsequent packets when the new temporary logical link identifier has been assigned.

The cellular communications network may be a GSM/EDGE radio access network.

Apparatus according to claim 20, wherein each packet includes a foreign temporary logical link identifier during the handover period.

The first routing area may be managed by a source serving controller and the second routing area is managed by a target serving controller. The source serving controller and the target serving controller are implemented as serving GPRS support nodes.

In a still further aspect the invention provides an apparatus for handing over communication of packet switched data from a mobile terminal moving between a first routing area defined in a cellular communications network and a second routing area wherein a local temporary logical link identifier has been assigned to said communication in the first routing area, the apparatus comprising a controller operable to identify that the mobile terminal has moved from the first routing area to the second routing area and to change the local temporary logical link identifier to a foreign temporary logical link identifier, wherein the mobile terminal is operable to transmit packets in an uplink direction during a handover period, each packet including the foreign temporary logical link identifier.

In another aspect the invention provides an apparatus for handing over communication of packet switched data in a wireless communications network, comprising: a controller operable to identify in a logical domain that a mobile terminal has moved to a new routing area and to supply in a physical domain a temporary handover identity to the mobile terminal; and a network entity operable to transmit, during a handover period, packets over a wireless interface to the mobile terminal each packet including a the temporary handover identity.

An aspect of the invention also provides a mobile terminal for establishing packet switched communication with a communication network, the communication network having at least two routing areas and means for detecting movement of the mobile terminal from one routing are to another, the mobile terminal including control receiving means for receiving a temporary handover identity responsive to detection of such movement by the communication network.

The mobile terminal may further include data receiving means fro receiving data packets, and identity detection means for identifying data packets including the temporary handover identity.

The mobile terminal may be provided with a local temporary logical link identifier associated with a current routing area, the mobile terminal further including means, responsive to initiation of a routing area update, for changing the local temporary logical link identifier to a foreign temporary logical link identifier.

The mobile terminal may be adapted to include the foreign temporary logical link identifier in every packet transmitted after initiation of the routing are update.

The mobile terminal may further include means for receiving a new local temporary logical link identifier on completion of the routing area update.

The mobile term may include means fro transmitting a routing are update request, the receiving means being configured to receive the temporary handover identity responsive to transmission of such request.

In general, the invention provides for a temporary handover identity or identifier for use for packet communications to and from a mobile station during a handover and pending completion of a routing area update.

### BRIEF DESCRIPTION OF THE FIGURES

For a better understanding of the present invention and to show how the same may be carried into effect, reference will now be made by way of example to the accompanying drawings, in which:

FIG. 1 is a schematic diagram of the access network and core network in a public land mobile network system;

FIG. 2 is a schematic diagram of the cellular nature of the network;

FIGS. 3a and 3b are schematic diagrams used to illustrate an embodiment of the invention; and

FIGS. 4a to 4c are schematic diagrams showing the change to packet structures in the course of the handover procedure in an embodiment of the invention.

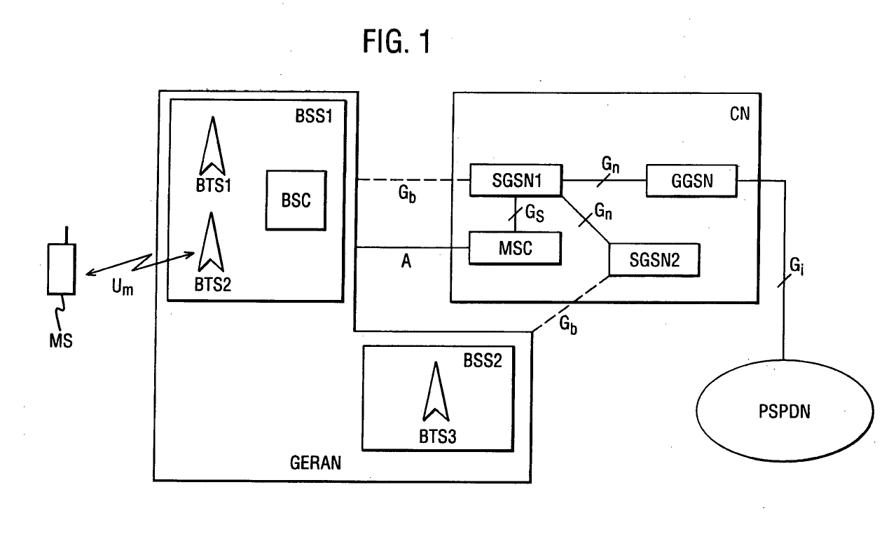

### DESCRIPTION OF THE PREFERRED EMBODIMENTS

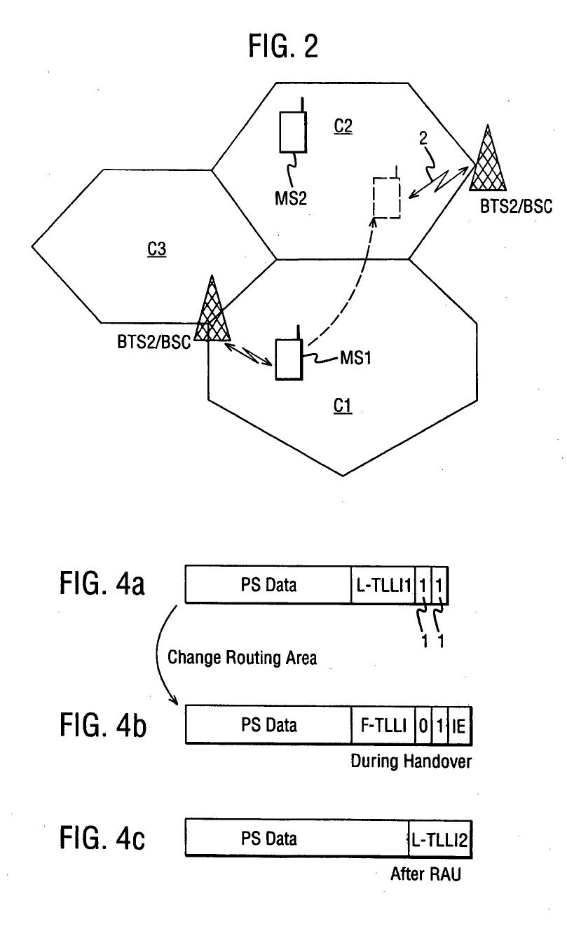

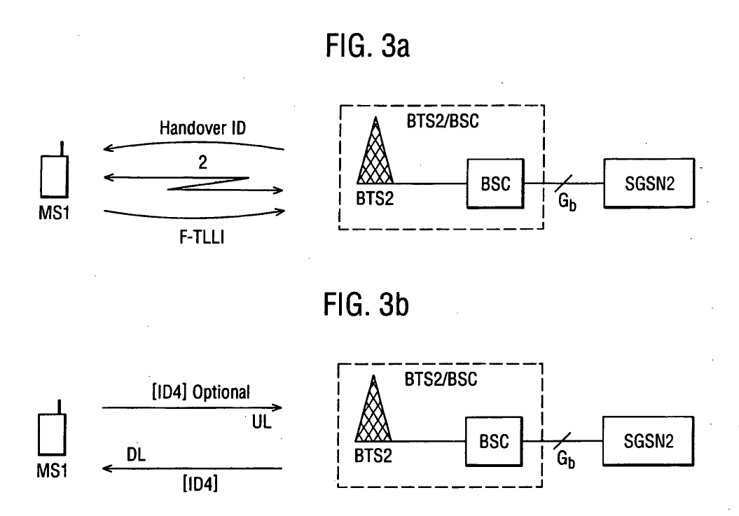

FIGS. 3a and 3b are schematic diagrams, which are used to describe one embodiment of the present invention. For the purposes of the described embodiment, it is assumed, as illustrated in FIG. 2, that a mobile station connected in a source cell C1 moves such that a handover to a target cell C2 must take place. For the purpose of the described embodiment, it is further assumed that the target cell C2 is in a different routing area (RA) than the source cell C1. Generally, it can be considered that the mobile station moves from a first routing area to a second routing area.

FIG. 3a shows a moving (or roaming) mobile station identified as MS1, a base transceiver station, identified as BTS2, of a target cell denoted as C2. The associated relevant network components of BTS2 are also shown: a base station controller, denoted, BSC and a serving GPRS support node denoted SGSN, being an SGSN of the target cell C2. For the purposes of handover, the SGSN is the ‘new’ SGSN.

All of the components shown in FIG. 3a have been individually described already in the above introduction. For the purpose of a discussion of embodiments of the present invention, the BTS and the BSC are referred to hereinafter simply as the BTS/BSC. The BTS/BSC is identified as BTS2/BSC, consistent with the terminology of FIG. 2. The combined BTS/BSC is denoted in FIG. 3a by a dashed box around the BSC and the BTS.

Upon packet switched handover, when the moving mobile station MS1 arrives in the target cell C2, it must exchange physical information with BTS2/BSC to identify itself. It does this across the Um interface via the radio channel denoted by reference numeral 2 in FIG. 3a. While accessing the target cell C2 during packet switched handover, before any communication requiring the MS identity to be transmitted towards network, the MS changes its L-TLLI assigned in previous routing area to a F-TLLI, and identifies itself with this F-TLLI. As discussed hereinabove the TLLI itself does not change, but it is now denoted as a foreign TLLI rather than a local TLLI.

As part of this physical information exchange, the mobile station may preferably indicate the F-TLLI to BTS2/BSC, and in turn BTS2/BSC may preferably provide the mobile station MS1 with a temporary handover identity, denoted ID 4. Alternatively, the mobile station MS1 may initiate a physical layer PHY with a random handover identity that is acknowledged by BTS 2/BSC, set by a physical information response. In addition, because the target cell C2 is in a different routing than the source cell C1, a routing area update procedure is dispatched by MS1 to the new SGSN, SGSN2. MS1 also identifies itself with the F-TLLI in the routing area update procedure.

In any event, as a result of the handover and/or routing area update procedures, the mobile station is provided, in embodiments of the invention, with a temporary handover identity.

As illustrated by FIG. 3b, the BTS2/BSC adds the temporary handover identity ID 4 into each downlink (DL) packet (data and signalling) transmitted from the BTS2/BSC and intended for the mobile station MS1, until the attachment procedure (RAU) is finished. This prevents collisions in the downlink direction of data transfer, and guarantees that only one mobile station receives the downlink packets even where a plurality of mobile stations in the target cells share the same F-TLLI. The temporary handover identity uniquely identifies the mobile station to which the packets are directed, thereby avoiding collisions.

When a new local TLLI has been assigned as a consequence of a successful RAU procedure to the new SGSN, SGSN2, that new TLLI is used in the subsequent packets in place of the foreign TLLI and the temporary handover ID. Thus after a successful RAU procedure, the new L-TLLI uniquely identifies packets for a particular mobile station.

During handover, collisions in the up link (UL) direction may be avoided by checking the routing area identifier (RAI) in the SGSN to distinguish between mobile stations sharing the same F-TLLI. However during handover, the mobile station preferably adds the temporary handover ID 4 to the uplink data and signalling packets so that the data can be identified in the network side as originating from a particular mobile station. BTS2/BSC is capable of identifying the source of the data from the temporary handover ID and may then transfer it to the correct logical link and towards the core network.

The handover ID can be inserted into the packet in the form of a short (for example 1 byte) information element (IE) as shown in FIGS. 4a to 4c which illustrate one example of how a packet structure changes as the mobile station moves around.

The packet of FIG. 4a holds a first local temporary logic link identifier, denoted L-TLLI1. As the mobile station receiving data along that logical link moves to a target cell it determines that it is no longer appropriate for the packets to carry a local TLLI, and changes the identifier to a foreign TLLI as indicated in the packet of FIG. 4b.

The foreign TLLI is denoted F-TLLI. The MS identifies itself with F-TLLI to the new governing base station, namely BTS2/BSC. The MS derives the F-TLLI from L-TLLI 1 by simply altering the status of one bit from a “1” to a “0” in the code sequence which indicates a TLLI. Other parts of the code sequence for the TLLI remain the same on creation of the F-TLLI. With regards to data transfer, the F-TLLI is used together with the temporary handover ID, as discussed hereinabove, so that when BTS2/BSC transmits downlink packets forwarded to it with this foreign TLLI, it inserts the temporary handover ID which it has determined to use for this mobile station MS1 into the packets in form of the information element IE also shown in the packet of FIG. 4(b).

When the MS has successfully accessed the target cell, the base station controller provides a cell update to the serving GPRS support node SGSN2. Because also routing changes are necessary upon packet switched handover to a new cell, the MS initiates a RAU procedure after it has accessed a new cell. On receipt of a routing area update RAU, the serving GPRS support node SGSN2 assigns a new P-TMSI identifier for the MS to be used in the new routing area. Upon completion of the attachment procedure (RAU), this new P-TMSI identifier is indicated by the new SGSN, SGSN2, to the MS. The MS then uses this P-TMSI identifier to derive a new L-TLLI, which is denoted L-TLLI2. The foreign TLLI is replaced in the packet by the new L-TLLI, L-TLLI2, as indicated in the packet in FIG. 4(c). The BTS2/BSC then no longer needs to insert the temporary handover identity into subsequent packets.

The embodiment of the invention described above has several advantages. It allows packet switched handover to be implemented using the foreign TLLI, which avoids the need to temporarily reallocate a TLLI unnecessarily in handover procedures.

Only a short temporary handover identity or identifier is needed to distinguish one mobile station from another. It is very unlikely that there will be a larger number of mobile stations switching with the same F-TLLI than a one byte length information element IE can accommodate.

The implementation of the invention does not affect the Gb interface between the base station controller BSC and the serving SGSN node at all—it is entirely implemented at the radio interface Um. Therefore it does not affect core network implementation details.

1. A method of handing over communication of packet switched data from a mobile terminal moving between a first routing area defined in a cellular communications network and a second routing area, wherein a temporary logical link identifier has been assigned to said communication in the first routing area, the method comprising the steps of:
identifying that the mobile terminal has moved from the first routing area to the second routing area;
supplying a temporary handover identity;
transmitting packets in a downlink direction to the mobile terminal during a handover period, each packet including the temporary handover identity; and
during said handover period, assigning a new temporary logical link identifier to the mobile terminal and ceasing to include the temporary handover identity in subsequent packets when the new temporary logical link identifier has been assigned.

2. The method according to claim 1, further comprising the step of:
selecting the cellular communications network to comprise a GSM/EDGE radio access network.

3. The method according to claim 1, further comprising the steps of:
selecting the temporary logical link identifier assigned to said communication in the first routing area to comprise a local temporary logical link identifier: and
after identifying that the mobile terminal has moved from the first routing area to the second routing area, changing the local temporary logical link identifier to a foreign temporary logical link identifier.

4. The method according to claim 3, further comprising the step of:
selecting each packet to comprise the foreign temporary logical link identifier during the handover period.

5. The method according to claim 3, further comprising the step of:
changing the local temporary logical link identifier to the foreign temporary logical link identifier by altering the status of one bit in a bit sequence representing the identifier.

6. The method according to claim 3, further comprising the step of:
assigning the new temporary logical link identifier after the handover period to comprise a new local temporary logical link identifier.

7. The method according to claim 1, further comprising the steps of:
managing the first routing area by a source serving controller and;
managing the second routing area by a target serving controller.

8. The method according to claim 7, further comprising the step of:
implementing the source serving controller and the target serving controller to comprise serving GPRS support nodes.

9. The method according to claim 1, wherein the step of identifying that the mobile terminal has moved from the first routing area to the second routing area further comprises the mobile terminal dispatching a routing area update message to a serving controller managing the second routing area.

10. The method according to claim 1, further comprises the steps of:
selecting the cellular communications network to comprise a plurality of cells; and
issuing a cell update message to a serving controller managing a target cell when a mobile station moves from a source cell of the cellular communications network to the target cell.

11. The method according to claim 1, further comprising the step of:
assigning the temporary logical link identifiers in a packet switched logical domain.

12. A method according to claim 1, further comprising the step of:
transmitting packets to the mobile terminal over a wireless interface.

13. The method according to claim 1, further comprising the step of:
including the temporary handover identity in packets transferred in an uplink direction from the mobile terminal to a base station.

14. The method according to claim 1, further comprising the step of:
selecting the packet to comprise data packets and signalling packets.

15. The method according to claim 1, further comprising the step of:
selecting the temporary handover identity to be in the form of an information element in each packet.

16. The method according to claim 15, further comprising the step of:
selecting the information element to be one byte in length.

17. A method according to claim 1, further comprising the step of:
selecting the temporary logical link identifier to comprise a packet temporary mobile subscriber identity (P-TMSI), said P-TMSI being included in each packet with the temporary handover identity.

18. A method of handing over communication of packet switched data from a mobile terminal moving between a first routing area defined in a cellular communications network and a second routing area wherein a local temporary logical link identifier has been assigned to said communication in the first routing area, the method comprising the steps of:
identifying that the mobile terminal has moved from the first routing area to the second routing area;
changing the local temporary logical link identifier to a foreign temporary logical link identifier; and
transmitting packets from the mobile terminal in an uplink direction during a handover period, each packet including the foreign temporary logical link identifier.

19. A method of handing over communication of packet switched data in a wireless communications network, the method comprising:
identifying in a logical domain that a mobile terminal has moved to a new routing area and supplying in a physical domain a temporary handover identity to the mobile terminal; and
during a handover period, transferring packets over a wireless interface to the mobile terminal, each packet including the temporary handover identity.

20. Apparatus for handing over communications of packet switched data from a mobile terminal moving between a first routing area defined in a cellular communications network and a second routing area, wherein a temporary logical link identifier has been assigned to said communications in the first routing area, the apparatus comprising:
a controller configured to identify that the mobile terminal has moved from the first routing area to the second routing area and to supply a temporary handover identify; and
a network entity configured to transmit packets in a downlink direction to the mobile terminal during a handover period, each packet including the temporary handover identity,
wherein the controller is configured to assign a new temporary logical link identifier to the mobile terminal and the network entity ceases to include the temporary handover identity in subsequent packets when the new temporary logical link identifier has been assigned.

21. The apparatus according to claim 20, wherein the network entity is included in the cellular communications network and wherein the cellular communications network comprises a GSM/EDGE radio access network.

22. The apparatus according to claim 20, wherein each packet includes a foreign temporary logical link identifier during the handover period.

23. The apparatus according to claim 20, wherein the network entity is included in the cellular communications network and wherein the first routing area defined in the cellular communications network is managed by a source serving controller and the second routing area is managed by a target serving controller.

24. The apparatus according to claim 23, wherein the network entity is included in the cellular communications network, and wherein the source serving controller and the target serving controller are implemented as serving-GPRS support nodes.

25. Apparatus for handing over communication of packet switched data from a mobile terminal moving between a first routing area defined in a cellular communications network and a second routing area wherein a local temporary logical link identifier has been assigned to said communication in the first routing area, the apparatus comprising:
a controller configured to identify that the mobile terminal has moved from the first routing area to the second routing area and to change the local temporary logical link identifier to a foreign temporary logical link identifier, wherein the mobile terminal is configured to transmit packets in an uplink direction during a handover period, each packet including the foreign temporary logical link identifier.

26. Apparatus for handing over communication of packet switched data in a wireless communications network, the apparatus comprising:
a controller configured to identify in a logical domain that a mobile terminal has moved to a new routing area and to supply in a physical domain a temporary handover identity to the mobile terminal; and
a network entity configured to transmit, during a handover period, packets over a wireless interface to the mobile terminal each packet including the temporary handover identity.

27. A mobile terminal for establishing packet switched communication with a communication network, the communication network comprising:
at least two routing areas; and
means for detecting movement of the mobile terminal from one routing area to another, the mobile terminal including control receiving means for receiving a temporary handover identity responsive to detection of such movement by the communication network.

28. The mobile terminal according to claim 27, wherein the mobile terminal further includes:
data receiving means for receiving data packets; and
identity detection means for identifying data packets including the temporary handover identity.

29. The mobile terminal according to claim 27, wherein the mobile terminal is provided with a local temporary logical link identifier associated with a current routing area, the mobile terminal further including:
means, responsive to initiation of a routing area update, for changing the local temporary logical link identifier to a foreign temporary logical link identifier.

30. The mobile terminal according to claim 29, wherein the mobile terminal is configured to include the foreign temporary logical link identifier in every packet transmitted after initiation of the routing area update.

31. The mobile terminal according to claim 30, wherein the mobile terminal further includes:
means for receiving a new local temporary logical link identifier upon completion of the routing area update.

32. The mobile terminal according to claim 27, wherein the mobile terminal further includes:
means for transmitting a routing area update request, the control receiving means being configured to receive the temporary handover identity responsive to transmission of such request.

33. A system for handing over communication of packet switched data from a mobile terminal moving between a first routing area defined in a cellular communications network and a second routing area, wherein a temporary logical link identifier has been assigned to said communication in the first routing area, the system comprising:
identifying means for identifying that the mobile terminal has moved from the first routing area to the second routing area;
supplying means for supplying a temporary handover identity;
transmitting means for transmitting packets in a downlink direction to the mobile terminal during a handover period, each packet including the temporary handover identity; and
control means for assigning, during said handover period, a new temporary logical link identifier to the mobile terminal and ceasing to include the temporary handover identity in subsequent packets when the new temporary logical link identifier has been assigned.
